(19) United States
(12) Patent Application Publication
(10) Pub. No.: US 2022/0356083 A1
(43) Pub. Date: Nov. 10, 2022

(54) Ion-Exchange Apparatus

(71) Applicant: Kabushiki Kaisha F.C.C., Hamamatsu-shi (JP)

(72) Inventors: Hironori Higuchi, Hamamatsu-shi (JP); Kentaro Ino, Hamamatsu-shi (JP); Makiko Endo, Hamamatsu-shi (JP)

(21) Appl. No.: 17/871,905

(22) Filed: Jul. 23, 2022

Related U.S. Application Data
(63) Continuation of application No. PCT/JP2020/044923, filed on Dec. 2, 2020.

(30) Foreign Application Priority Data
Feb. 18, 2020 (JP) 2020-024851

(51) Int. Cl. C02F 1/42; C02F 1/44; B01D 63/08; B01D 63/06; B01D 63/02; B01D 69/02; B01D 67/00; B01D 15/36; B01J 47/12

(52) U.S. Cl. CPC C02F 1/42; C02F 1/44; B01D 63/087; B01D 63/081; B01D 63/061; B01D 63/021; B01D 69/02; B01D 67/0088; B01D 67/009; B01D 15/361; B01J 47/12; C02F 2001/422; C02F 2001/425; C02F 2103/023

(57) ABSTRACT

An ion-exchange apparatus includes a raw-water tank 1, a treatment section, an ion exchanger and a hydrophilic layer. The raw-water section contains a liquid to be treated with impurity ions. The treatment tank 2 contains a treatment material with exchange ions exchangeable with the impurity ions. The ion exchanger 3 enables the passage of the impurity ions from the raw-water tank 1 to the treatment tank 2 and the passage of the exchange ions from the treatment tank 2 to the raw-water tank 1. The hydrophilic layer M, with a water contact angle of 30° or less, is disposed on at least a surface of the ion exchanger adjacent to the treatment tank 2.

### CROSS-REFERENCE TO RELATED APPLICATIONS

This application is a continuation of International Application No. PCT/JP2020/044923, filed Dec. 2, 2020, which claims priority to Japanese Application No. 2020-024851, filed Feb. 18, 2020. The disclosures of the above applications are incorporating herein by reference.

### FIELD

The present disclosure relates to an ion-exchange apparatus removing impurity ions from a to be treated liquid.

### BACKGROUND

Various ion-exchange apparatuses have recently been reported for softening industrial water, producing pure water, purifying drinking water, cooling water for vehicles, and so forth by removing impurity ions in to be treated liquids. For example, ion-exchange apparatuses packed with ion-exchange resins that are ion exchangers formed into granular shapes have been reported. For example, as disclosed in Japanese Unexamined Patent Application Publication No. S62-14948 and Japanese Unexamined Patent Application Publication No. 2002-136968, apparatuses have been disclosed for adsorbing and removing impurity ions by packing a granular ion-exchange resin into a container and passing a to be treated liquid through the container.

### SUMMARY

However, in the above-described known techniques, ion-exchange capacities are as small as about 1.5 to about 2 meq/cm³. Thus, when higher performance is required, problems exist, for example, where expensive ion-exchange resins are needed. This increases production costs. Also, large holding members for holding ion-exchange resins are required. This increases the whole sizes of ion-exchange apparatuses.

To reduce the size of such an apparatus without requiring an expensive ion-exchange resin, the present an ion-exchange apparatus includes a raw-water section, a treatment section, and an ion exchanger. The raw water section contains a to be treated liquid with impurity ions. The treatment section contains a treatment material with exchange ions including ions exchangeable with the impurity ions. The ion exchanger enables passage of the impurity ions from the raw-water section to the treatment section and passage of the exchange ions from the treatment section to the raw-water section.

The ion-exchange apparatus can satisfactorily remove impurity ions in the raw-water section by interposing the ion exchanger between the raw-water section and the treatment section. It is anticipated, however, that there will be further demand for reducing the amount of treatment material in the treatment section that permeates the raw-water section. Thus, the applicant has conducted intensive studies on an ion-exchange apparatus that can also satisfy these requirements.

The present disclosure has been made in view of the foregoing circumstances. It is an object of the present disclosure to provide an ion-exchange apparatus that increases ion-exchange capacity without requiring an expensive ion exchanger and reduces the amount of treatment material that permeates a raw-water section.

According to the disclosure, an ion-exchange apparatus includes a raw-water section, a treatment section, an ion exchanger and a hydrophilic layer. The raw-water section contains a to be treated liquid. The liquid includes a liquid that contains impurity ions. The treatment section contains a treatment material with exchange ions including ions exchangeable with the impurity ions. The ion exchanger enables passage of the impurity ions from the raw-water section to the treatment section and passage of the exchange ions from the treatment section to the raw-water section. The hydrophilic layer, with a water contact angle of 30° or less, is disposed on at least a surface of the ion exchanger adjacent to the treatment section.

The ion-exchange apparatus ion exchanger has a tubular shape, a flat-film shape, or a hollow-fiber shape.

The ion-exchange apparatus ion exchanger is disposed on a support including a sheet-like fiber layer.

The ion-exchange apparatus treatment material, in the treatment section, has a higher molarity than the to be treated liquid in the raw-water section.

The ion-exchange apparatus treatment material, in the treatment section, has a molarity of 2 mol/L or more.

The ion-exchange apparatus raw-water section has a packed ion exchanger in contact with the ion exchanger that enables passage of the impurity ions from the raw-water section to the treatment section and passage of the exchange ions from the treatment section to the raw-water section.

The ion-exchange apparatus packed ion exchanger, in the raw-water section, includes ion-exchange fibers.

The ion-exchange apparatus raw-water section enables flow of the to be treated liquid.

The ion-exchange apparatus treatment section enables the treatment material to flow in the direction opposite to the to be treated liquid.

The ion-exchange apparatus further includes an auxiliary treatment section packed with a granular ion exchanger. The auxiliary treatment section is connected downstream of the raw-water section. The to be treated liquid passed through the raw-water section flows into the auxiliary treatment section.

The ion-exchange apparatus treatment section includes a stirrer for stirring the treatment material.

The ion-exchange apparatus includes a seal that seals at least one of a joint portion between the raw-water section and the ion exchanger and a joint portion between the treatment section and the ion exchange.

The ion-exchange apparatus exchange ions are group 1 element ions or hydroxide ions.

The ion exchange apparatus treatment material contains a weak acid or a weak base.

The ion-exchange apparatus includes a first treatment section, where the exchange ions are group 1 element ions, and a second treatment section, where the exchange ions are hydroxide ions. Each of the first treatment section and the second treatment section is connected to the raw-water section with the ion exchanger provided therebetween.

A method for producing an ion-exchange apparatus. The apparatus includes a raw-water section, a treatment section, an ion exchanger and a hydrophilic layer. The raw-water section contains a to be treated liquid that contains impurity ions. The treatment section contains a treatment material with exchange ions including ions exchangeable with the impurity ions. The ion exchanger enables passage of the impurity ions from the raw-water section to the treatment section and passage of the exchange ions from the treatment section to the raw-water section. The hydrophilic layer, having a water contact angle of 30° or less, is on at least a surface of the ion exchanger adjacent to the treatment section.

The method for producing an ion-exchange apparatus wherein the hydrophilic layer is formed by subjecting the surface of the ion exchanger adjacent to the treatment section to irradiation of an actinic energy ray, corona treatment, plasma treatment, or coating treatment.

According to the present disclosure, the ion-exchange apparatus includes the raw-water section, treatment section, an ion exchanger and a hydrophilic layer. The raw-water section contains a to be treated liquid. The liquid includes a liquid that contains impurity ions. The treatment section contains a treatment material with exchange ions including ions exchangeable with the impurity ions. The ion exchanger enables passage of the impurity ions from the raw-water section to the treatment section and passage of the exchange ions from the treatment section to the raw-water section. The hydrophilic layer, having a water contact angle of 30° or less, is disposed on at least a surface of the ion exchanger adjacent to the treatment section. Thus, it is possible to increase an ion-exchange capacity without requiring an expensive ion exchanger and to reduce the amount of treatment material that permeates the raw-water section.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of an ion-exchange apparatus according to a first embodiment.

FIG. 2 is a graph illustrating a technical effect of the ion-exchange apparatus.

FIG. 3 is a schematic view of another ion-exchange apparatus according to the embodiment.

FIG. 4 is a schematic view of another ion-exchange apparatus according to the embodiment.

FIG. 5 is a schematic view of another ion-exchange apparatus according to the embodiment.

FIG. 6 is a schematic view of another ion-exchange apparatus according to the embodiment.

FIG. 7 is a schematic view of another ion-exchange apparatus according to the embodiment.

FIG. 8 is a schematic view of an ion-exchange apparatus according to a second embodiment.

FIG. 9 is a schematic view of an ion-exchange apparatus according to yet another embodiment.

FIG. 10 is a schematic view of an ion-exchange apparatus according to yet another embodiment.

FIG. 11 is a schematic view of an ion-exchange apparatus according to yet another embodiment.

FIG. 12 is a schematic view of an ion-exchange apparatus according to a third embodiment.

FIG. 13 is a schematic view of an ion-exchange apparatus according to a fourth embodiment.

FIG. 14 is a schematic view of an ion-exchange apparatus according to a fifth embodiment.

FIG. 15 is a schematic view of an ion-exchange apparatus according to another embodiment.

FIG. 16 is a schematic view of an ion-exchange apparatus according to a sixth embodiment.

FIG. 17 is a schematic view of an ion-exchange apparatus according to another embodiment.

FIG. 18 is a table presenting experimental results in Examples 1 to 6 and Comparative examples 1 and 2.

FIG. 19 is a table presenting experimental results in Examples 7 to 9.

FIG. 20 is a table presenting experimental results in Examples 10 to 18.

FIG. 21 is a table presenting experimental results in Examples 19 and 20 and Comparative example 3.

FIG. 22 is a table presenting experimental results in Examples 21 and 22.

FIG. 23 is a table presenting experimental results in Examples 23 and 24.

### DETAILED DESCRIPTION

Embodiments of the present disclosure will be specifically described below with reference to the drawings.

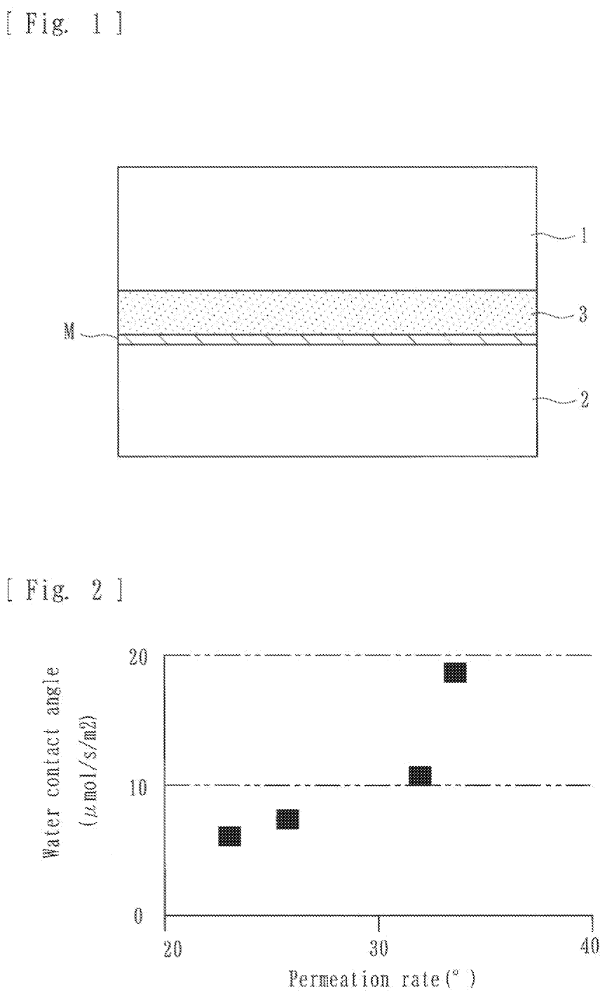

An ion-exchange apparatus according to this embodiment is used to soften industrial water, produce pure water, or purify, for example, drinking water and cooling water for vehicles by removing impurity ions in liquids to be treated. An example of an ion-exchange apparatus according to a first embodiment is illustrated in FIG. 1. The ion-exchange apparatus includes a raw-water tank 1 (raw-water section), a treatment tank 2 (treatment section), and an ion exchanger 3.

The raw-water tank 1 is a section containing a to be treated liquid. The liquid contains impurity ions. Examples of the to be treated liquid include solutions containing K⁺ (potassium ion) and Na⁺ (sodium ion) as impurity cations and solutions containing CO₃²⁻ (carbonate ion) and Cl⁻ (chloride ion) as impurity anions. The raw-water tank 1 according to the present embodiment contains a predetermined volume of a to be treated liquid (water to be treated) containing these impurity cations and impurity anions.

The treatment tank 2 is a section containing a treatment material (liquid in the present embodiment) with exchange ions exchangeable with impurity ions. Examples include acid-containing solution tanks and alkali-containing solution tanks. In the case of an acid-containing solution tank, for example, a solution containing H⁺ (hydrogen ion) as an exchange ion, specifically, a solution containing Cl⁻ in addition to H⁺ as an exchange ion, is contained. In the case of an alkali-containing solution tank, for example, a solution containing OH⁻ (hydroxide ion) as an exchange ion, specifically, a solution containing Na⁺ in addition to OH⁻ as an exchange ion, is contained.

The ion exchanger 3 permits the passage of impurity ions from the raw-water tank 1 to the treatment tank 2 or the passage of exchange ions from the treatment tank 2 to the raw-water tank 1. For example, an ion-exchange resin, a chelating resin, phosphogypsum, Nafion, zeolite, hydrotalcite, or a metal oxide can be used. The ion exchanger 3 according to the present embodiment is disposed between the raw-water tank 1 and the treatment tank 2 and has a flat-film shape. When impurity ions are cations, a cation exchanger is used and functions by allowing only impurity ions and exchangeable cations in the treatment material to mutually pass through. When impurity ions are anions, an anion exchanger is used and functions by enabling impurity ions and exchangeable anions in the treatment material to mutually pass through. In this way, impurity ions can be removed from the raw water.

In the ion-exchange apparatus according to the present embodiment, the solution (treatment material) in the treatment tank 2 has a higher molarity than the to be treated liquid in the raw-water tank 1. That is, the concentration (molarity) of the exchange ions in the treatment tank 2 is set higher than that of the impurity ions in the to be treated liquid in the raw-water tank 1. Thus, when the impurity ions are adsorbed by the ion exchanger 3, the impurity ions move in the ion exchanger 3 because of the concentration difference and are released into the treatment tank 2. The exchange ions in the treatment tank 2 move in the ion exchanger 3 and are released into the raw-water tank 1.

That is, when impurity ions in the raw-water tank 1 come into contact with the ion exchanger 3, because of the concentration difference or ion selectivity, the impurity ions are replaced with ions of the ion exchanger 3. The ions are sequentially replaced up to a portion of the ion exchanger 3 on the treatment tank 2 side. In this way, the impurity ions coming into contact with the ion exchanger 3 pass through the ion exchanger 3 from the raw-water tank 1 toward the treatment tank 2. The impurity ions are then replaced with the exchange ions in the treatment tank 2 and move into the treatment tank 2 because of a high molarity (exchange ion concentration) in the treatment tank 2. Thereby, the impurity ions in the raw-water tank 1 can be removed.

For example, an ion-exchange apparatus will be described where a membrane-like ion exchanger 3 (anion exchanger) is used, represented by a structural formula containing OH⁻. A solution containing Cl⁻ as an impurity ion (anion) is contained in the raw-water tank 1. A treatment material, containing exchange ions, such as Na⁺ and OH⁻, is contained in the treatment tank 2. In this case, Cl⁻ as an impurity ion in the raw-water tank 1 is replaced with OH— in the ion exchanger 3. The taken impurity ions (Cl⁻) are sequentially replaced with OH⁻ ions in the ion exchanger 3 because of ion selectivity characteristics where ions having a higher valence or a larger atomic or molecular size are more easily exchanged.

In the present embodiment, the treatment material in the treatment tank 2 has a higher molarity than the to be treated liquid in the raw-water tank 1. Thus, the impurity ions (Cl⁻) taken into the ion exchanger 3 are replaced with the exchange ions (OH⁻) in the treatment tank 2. Thereby, the impurity ions (Cl⁻) in the raw-water tank 1 are moved to the treatment tank 2 and removed. Nat, which is a cation, repels N⁺ in the ion exchanger 3 and thus does not readily move into the raw-water tank 1.

When the treatment tank 2 contains a solution containing an acid, anions in the raw-water tank 1 repel anions, such as sulfonic groups, in the ion exchanger 3 (cation exchanger) and cannot pass through the ion exchanger 3. When the treatment tank 2 contains a solution containing an alkali, cations in the raw-water tank 1 repel cations, such as quaternary ammonium groups, in the ion exchanger 3 (anion exchanger) and cannot pass through the ion exchanger 3.

As described above, the ion exchanger 3, according to the present embodiment, includes a membrane-like member with the properties of blocking the passage of ions with different electric charges and different signs and enabling the passage of only ions with the same electric charge and the same sign. It is configured for the purpose of filtering impurity ions. The ion exchanger 3 that enables only cations to pass through is referred to as a positive ion-exchange membrane (cation-exchange membrane). The ion exchanger 3 that enables only anions to pass through is referred to as a negative ion-exchange membrane (anion-exchange membrane).

Thus, the pressure in the raw-water tank 1 is preferably higher than the pressure in the treatment tank 2. The liquid pressure of the to be treated liquid in the raw-water tank 1 is higher than the pressure of the solution in the treatment tank 2. In this case, it is possible to suppress the passage of ions that are contained in the treatment tank 2 and that are not desired to be moved into the raw-water tank 1 through the ion exchanger 3. For example, the to be treated liquid flows in the raw-water tank 1 and the pressure in the raw-water tank 1 can be higher than the pressure in the treatment tank 2 by the flow resistance.

Here, in the ion-exchange apparatus according to the present embodiment, a hydrophilic layer M, having a water contact angle of 30° or less, is disposed on at least a surface (lower surface in FIG. 1) of the ion exchanger 3 adjacent to the treatment tank 2. The hydrophilic layer M is formed by subjecting the surface of the ion exchanger 3, adjacent to the treatment tank 2, to irradiation of an actinic energy ray, corona treatment, plasma treatment, or coating treatment. An example is a substance, such as PVA. Hydrophilicity is a physical property that indicates an affinity with water (H₂O). The water contact angle (θ: water contact angle) is an index of hydrophilicity and defined as “the angle between a liquid surface and a solid surface at a place where the free surface of a static liquid is in contact with a solid wall (angle in the liquid).

When impurity ions in the raw-water tank 1 were removed with such an ion-exchange apparatus, experimental results as illustrated in FIG. 2 were obtained by forming hydrophilic layers M having various water contact angles. That is, it was found that the hydrophilic layer M with a smaller water contact angle and higher hydrophilicity had a lower permeation rate (μmol/s/m²) where the treatment material permeated the raw-water tank 1 from the treatment tank 2. In particular, when the hydrophilic layer M had a water contact angle of 30° or less, the permeation rate was significantly low.

The reason for this is thought to be as follows: Ions are easily dissociated in the hydrophilic layer M. When the ion exchanger 3 is a cation exchanger, the ion exchanger 3 has an anionic charge. When the ion exchanger 3 is an anion exchanger, the ion exchanger 3 has a cationic charge. Ions having the same sign repel the charge of the ion exchanger 3 and are difficult to permeate. Thus, the permeation rate is reduced where the treatment material permeates the raw-water tank 1 from the treatment tank 2. Accordingly, it is possible to reduce the amount of treatment material that permeates the raw-water tank 1 and to suppress the contamination of the to be treated liquid with a large amount of treatment material.

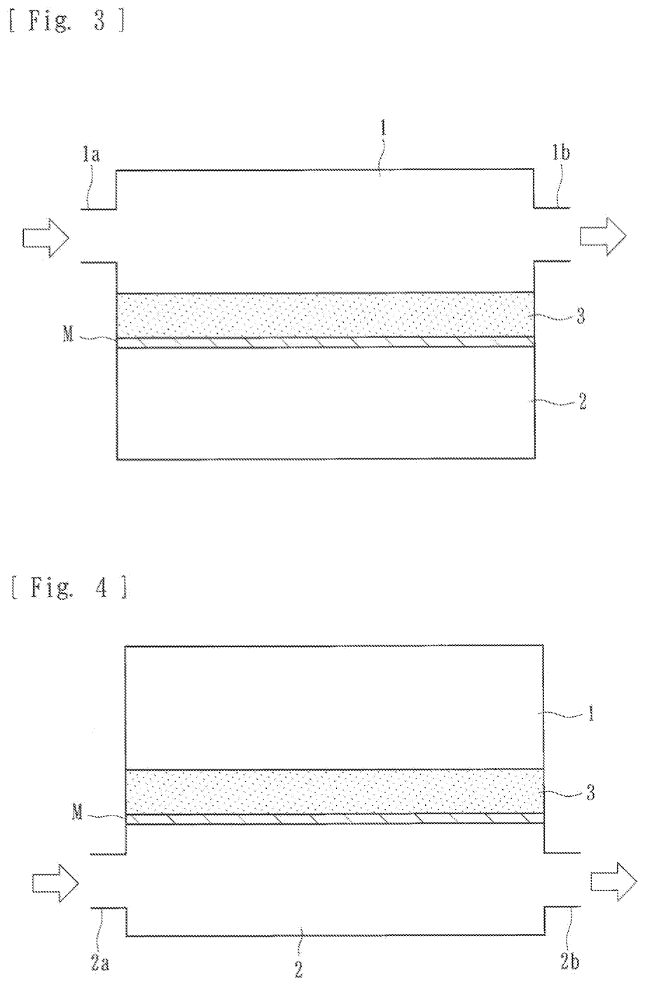

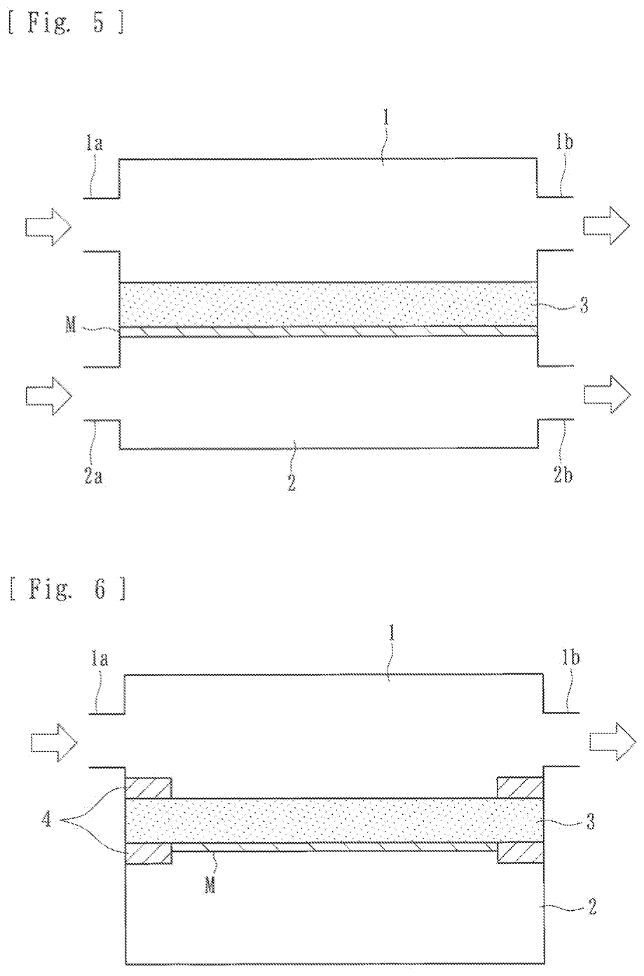

The to be treated liquid in the raw-water tank 1 and the solution (treatment material) in the treatment tank 2 according to the present embodiment are in a non-flowing state. As illustrated in FIG. 3, the raw-water tank 1 may include an inlet 1a and an outlet 1b enable flow of the to be treated liquid in the raw-water tank 1. As illustrated in FIG. 4, the treatment tank 2 may include an inlet 2a and an outlet 2b to enable flow of the solution (treatment material) in the treatment tank 2. As illustrated in FIG. 5, the raw-water tank 1 may include the inlet 1a and the outlet 1b to enable flow of the to be treated liquid, and the treatment tank 2 may include the inlet 2a and the outlet 2b to enable the treatment material. When only the to be treated liquid is enabled to flow, the impurity ions can be continuously removed with a simple configuration, which is preferred.

As illustrated in FIG. 6, a seal 4, such as gaskets, may be provided at a joint portion between the raw-water tank 1 (raw-water section) and the ion exchanger 3 and at a joint portion between the treatment tank 2 (treatment section) and the ion exchanger 3. In this case, it is sufficient that the seal 4 is disposed in at least one of the joint portion between the raw-water tank 1 (raw-water section) and the ion exchanger 3 and the joint portion between the treatment tank 2 (treatment section) and the ion exchanger 3.

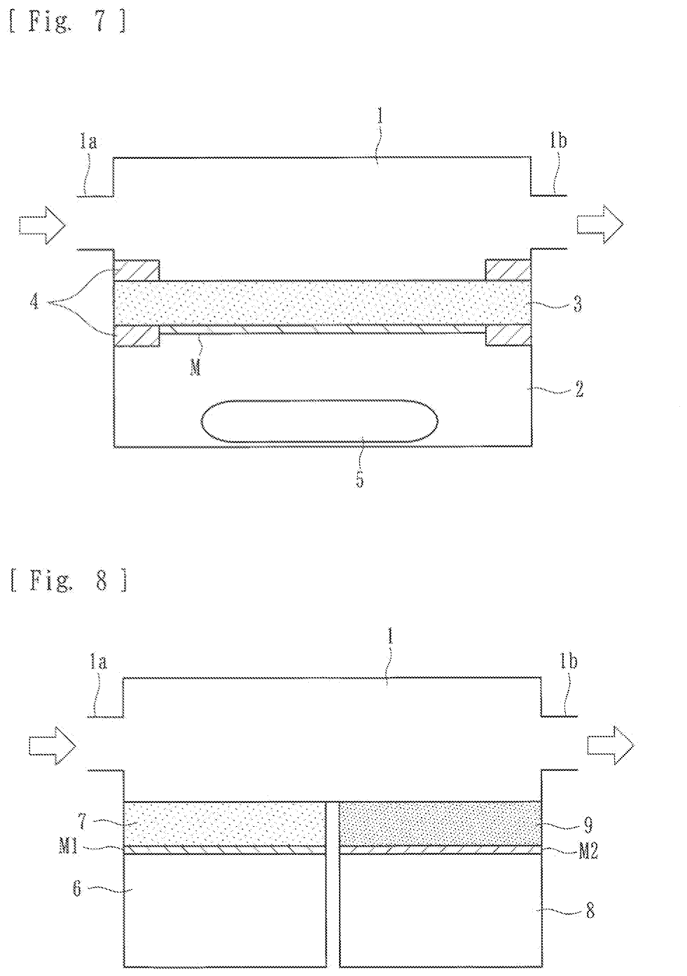

As illustrated in FIG. 7, the treatment tank 2 (treatment section) may include a stirrer 5, such as an impeller, to stir the solution (treatment material). In this case, the impurity ions that have passed through the ion exchanger 3 from the to be treated liquid in the raw-water tank 1 and have reached the treatment tank 2 are mixed in the solution (treatment material) and then stirred with the stirrer 5, enabling a further improvement in ion-exchange efficiency.

In the ion-exchange apparatus according to the present embodiment, the solution (treatment material) in the treatment tank 2 preferably has a molarity of 2 mol/L or more. A molarity of 2 mol/L or more results in an ion-exchange apparatus having a higher ion-exchange capacity than existing ion-exchange resins. The exchange ions in the treatment tank 2 are group 1 element ions or hydroxide ions, and may contain a weak acid or a weak base. The ion exchanger 3 may include an ion-exchange resin membrane or may be disposed on a support including a sheet-like fiber layer.

Preferably, the sheet-like fiber layer as a support includes cellulose fibers and has a thickness dimension of, for example, 0.05 mm or more and 0.3 mm or less, preferably about 0.15 mm. More specifically, the fiber layer is preferably obtained by using pulp, such as cellulose, or PET fibers with high water resistance and chemical resistance as a material and forming the material into a sheet-like (paper-like) shape by a sheet-making method (paper-making method).

In the ion-exchange apparatus according to the present embodiment, the raw-water tank 1 is packed with the ion exchanger F in contact with the ion exchanger 3. The ion exchanger F plays the same role as the ion exchanger 3, adsorbs impurity ions and enables the impurity ions to pass through the inside of the ion exchanger F and to move to the ion exchanger 3 owing to the concentration difference. After that, the impurity ions can be moved to the treatment tank 2 through the inside of the ion exchanger 3. The ion exchanger F can have a spherical or fiber shape and can have a larger surface area than the ion exchanger 3. This enables efficient removal of the impurity ions from the raw water. In particular, in the case of the fiber shape, it is preferable to use a sheet shape, such as nonwoven fabric, because the entanglement of the fibers provides wide paths through which the impurity ions are moved to the ion exchanger 3, and thus high ion exchange velocity can be obtained.

A second embodiment according to the present disclosure will be described below.

As with the first embodiment, an ion-exchange apparatus according to this embodiment is used to soften industrial water, produce pure water, or purify, for example, drinking water or cooling water for vehicles by removing impurity ions in liquids to be treated. As illustrated in FIG. 8, it includes the raw-water tank 1, a first treatment tank 6 (first treatment section), a cation exchanger 7, a second treatment tank 8 (second treatment section), and an anion exchanger 9.

The raw-water tank 1 according to the present embodiment includes the inlet 1a and the outlet 1b so that a to be treated liquid can flow. As with the first embodiment, in the raw-water tank 1, a solution containing K⁺ (potassium ion) and Na⁺ (sodium ion) as impurity cations or a solution containing CO₃²⁻ (carbonate ion) and Cl⁻ (chloride ion) as impurity anions is contained and flows. However, the types of impurity ions are not limited to these.

The first treatment tank 6 is a section containing a solution (treatment material) with exchange ions of group 1 element ions, for example, a solution that contains H⁺ (hydrogen ion) serving as an exchange ion, specifically, a solution that contains Cl⁻ in addition to H⁺ serving as the exchange ion. The second treatment tank 8 is a section containing a solution (treatment material) with exchange ions including hydroxide ions, for example, a solution that contains OH⁻ (hydroxide ion) serving as an exchange ion, specifically, a solution that contains Na⁺ in addition to OH⁻ serving as the exchange ion.

The first treatment tank 6 and the second treatment tank 8 communicate with the raw-water tank 1 with the ion exchangers (the cation exchanger 7 and the anion exchanger 9, respectively) provided between them. The cation exchanger 7 and the anion exchanger 9 are similar to the ion exchanger 3 in the first embodiment and enable the passage of impurity ions from the raw-water tank 1 to the first treatment tank 6 and the second treatment tank 8 or the passage of exchange ions from the first treatment tank 6 and the second treatment tank 8 to the raw-water tank 1.

In the ion-exchange apparatus according to the present embodiment, each of the solutions (treatment material) in the first treatment tank 6 and the solution (treatment material) in the second treatment tank 8 has a higher molarity than the to be treated liquid in the raw-water tank 1. That is, the concentration (molarity) of the exchange ions contained in each of the first treatment tank 6 and the second treatment tank 8 is set higher than that of the impurity ions in the to be treated liquid contained in the raw-water tank 1. Thus, when the impurity ions are adsorbed by the cation exchanger 7 and the anion exchanger 9, the impurity ions move in the cation exchanger 7 and the anion exchanger 9 because of the concentration difference and are released into the first treatment tank 6 and the second treatment tank 8. The exchange ions in the first treatment tank 6 and the second treatment tank 8 move in the cation exchanger 7 and the anion exchanger 9 and are released into the raw-water tank 1.

That is, on the first treatment tank 6 side, when impurity ions in the raw-water tank 1 come into contact with the cation exchanger 7, the impurity ions are replaced with ions of the cation exchanger 7. The ions are sequentially replaced up to a portion of the cation exchanger 7 adjacent to the first treatment tank 6 because of the concentration difference and ion selectivity. Thus, the impurity ions that have come into contact with the cation exchanger 7 pass through the cation exchanger 7 from the raw-water tank 1 toward the first treatment tank 6, are replaced with the exchange ions in the first treatment tank 6 and move into the first treatment tank 6 because of a high molarity (exchange ion concentration) in the first treatment tank 6. In this way, impurities (cationic impurities) in the raw-water tank 1 can be moved into the first treatment tank 6 and removed.

On the second treatment tank 8 side, when impurity ions in the raw-water tank 1 come into contact with the anion exchanger 9, the impurity ions are replaced with ions of the anion exchanger 9. The ions are sequentially replaced up to a portion of the anion exchanger 9 adjacent to the second treatment tank 8 because of ion selectivity. Thus, the impurity ions that have come into contact with the anion exchanger 9 pass through the anion exchanger 9 from the raw-water tank 1 toward the second treatment tank 8, are replaced with the exchange ions in the second treatment tank 8, and move into the second treatment tank 8 because of a high molarity (exchange ion concentration) in the second treatment tank 8. In this way, impurities (anionic impurities) in the raw-water tank 1 can be moved into the second treatment tank 8 and removed.

On the first treatment tank 6 side, anions in the raw-water tank 1 repel anions, such as sulfonic groups, in the cation exchanger 7 and cannot pass through the cation exchanger 7. On the second treatment tank 8 side, the cations in the raw-water tank 1 repel cations, such as quaternary ammonium groups, in the anion exchanger 9 and cannot pass through the anion exchanger 9.

Here, in the ion-exchange apparatus according to the present embodiment, hydrophilic layers M1 and M2, having a water contact angle of 30° or less, are disposed on at least surfaces (lower surfaces in FIG. 8) of the ion exchangers 7 and 9 adjacent to the treatment tanks 6 and 8, respectively. As with the hydrophilic layer M according to the first embodiment, the hydrophilic layers M1 and M2 are formed by subjecting the surface of the ion exchangers 7 and 9 adjacent to the treatment tanks 6 and 8 to irradiation of an actinic energy ray, corona treatment, plasma treatment, or coating treatment. An example thereof is a substance, such as PVA.

As with the hydrophilic layer M according to the first embodiment, ions are easily dissociated in the hydrophilic layers M1 and M2. When the ion exchangers 7 and 9 are cation exchangers, the ion exchangers 7 and 9 have an anionic charge. When the ion exchangers 7 and 9 are anion exchangers, the ion exchangers 7 and 9 have a cationic charge. Ions having the same sign repel the charge of the ion exchangers 7 and 9 and are difficult to permeate. Thus, the permeation rate at which the treatment material permeates the raw-water tank 1 from the treatment tanks 6 and 8 is seemingly reduced. Accordingly, it is possible to reduce the amount of treatment material that permeates the raw-water tank 1 and to suppress the contamination of the to be treated liquid with a large amount of treatment material.

Thus, the pressure in the raw-water tank 1 is preferably higher than the pressure in the first treatment tank 6 and the second treatment tank 8. The liquid pressure of the to be treated liquid in the raw-water tank 1 is higher than the pressure of the solution of each of the first treatment tank 6 and the second treatment tank 8. In this case, it is possible to suppress the passage of ions that are contained in the first treatment tank 6 and the second treatment tank 8 and that are not desired to be moved into the raw-water tank 1 through the cation exchanger 7 and the anion exchanger 9. For example, when the to be treated liquid flows in the raw-water tank 1, the pressure in the raw-water tank 1 can be higher than the pressure in the first treatment tank 6 and the second treatment tank 8 by the flow resistance.

As illustrated in FIG. 6 in the first embodiment, the seal 4, such as gaskets, may be provided at joint portions between the raw-water tank 1 (raw-water section) and the cation exchanger 7 and between the raw-water tank 1 and the anion exchanger 9, and at joint portions between the first treatment tank 6 and the cation exchanger 7 and between the second treatment tank 8 and the anion exchanger 9. In this case, as in the first embodiment, it is sufficient that the seal 4 is disposed at least one of the joint portions between the raw-water tank 1 (raw-water section) and the cation exchanger 7 and between the raw-water tank 1 and the anion exchanger 9 and the joint portion between the first treatment tank 6 and the cation exchanger 7 and between the second treatment tank 8 and the anion exchanger 9.

As illustrated in FIG. 7 in the first embodiment, the first treatment tank 6 and the second treatment tank 8 may include the stirrer 5, such as impellers, to stir the solutions (treatment materials). In this case, the impurity ions that have passed through the cation exchanger 7 and the anion exchanger 9 from the to be treated liquid in the raw-water tank 1 and have reached the first treatment tank 6 and the second treatment tank 8 are mixed in the solution (treatment material) and then stirred with the stirrer 5, thereby enabling a further improvement in ion-exchange efficiency.

In the ion-exchange apparatus according to the present embodiment, each of the solutions (treatment materials) in the treatment tanks 6 and 8 preferably has a molarity of 2 mol/L or more. The exchange ions in the treatment tanks 6 and 8 are group 1 element ions or hydroxide ions and may contain a weak acid or a weak base. Each of the cation exchanger 7 and the anion exchanger 9 includes, for example, an ion-exchange resin membrane, a chelating resin, phosphogypsum, Nafion, zeolite, hydrotalcite, or a metal oxide, or may be disposed on a support including a sheet-like fiber layer.

According to the above-described embodiment, the ion-exchange apparatus includes the raw-water tank 1, a treatment section, an ion exchanger and a hydrophilic layer. The raw-water section contains a to be treated liquid. The liquid includes a liquid that contains impurity ions. The treatment tank (2, 6, 8) contains a treatment material with exchange ions including ions exchangeable with the impurity ions. The ion exchanger (3, 7, 9) enables the passage of the impurity ions from the raw-water tank 1 to the treatment tank (2, 6, 8) and the passage of the exchange ions from the treatment tank (2, 6, 8) to the raw-water tank 1. The hydrophilic layer (M, M1, M2), having a water contact angle of 30° or less, is disposed on at least a surface of the ion exchanger adjacent to the treatment tank. Thus, it is possible to increase an ion-exchange capacity without requiring an expensive ion exchanger and to reduce the amount of treatment material that permeates the raw-water tank 1.

According to the above-described embodiment, the ion-exchange apparatus includes the raw-water tank, a treatment section, an ion exchanger and a hydrophilic layer. The raw-water section contains a to be treated liquid. The liquid includes a liquid that contains impurity ions. The treatment tank, including the first treatment tank and the second treatment tank, contains a treatment material with exchange ions including ions exchangeable with the impurity ions. The ion exchanger, including the cation exchanger and the anion exchanger, enables the passage of the impurity ions from the raw-water tank to the treatment tank and the passage of the exchange ions from the treatment tank to the raw-water tank. The treatment material in the treatment tank has a higher molarity than the to be treated liquid in the raw-water tank. Thus, it is possible to provide the inexpensive ion-exchange apparatus without using a large amount of an expensive ion exchanger. Additionally, the amount (density) of the exchangeable ions in the treatment material is larger than those of existing ion-exchange resins, thus enabling an increase in ion-exchange capacity per volume.

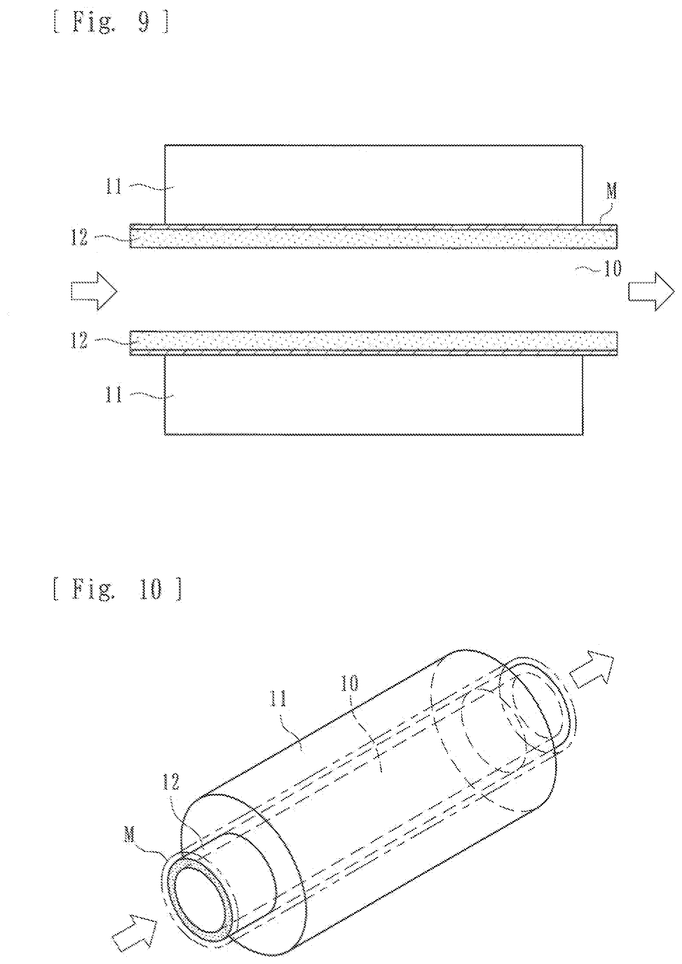

In the first and second embodiments and other embodiments related thereto, the ion exchanger 3, the cation exchanger 7, and the anion exchanger 9 are in the form of a flat-film shape. As illustrated in FIGS. 9 and 10, a tubular (pipe-shaped) ion exchanger 12 may be used. In this case, the inside of the tubular ion exchanger 12 is a raw-water section 10 similar to the raw-water tank 1, and the outside is a treatment section 11 similar to the treatment tank 2. The first treatment tank 6, or the second treatment tank 8. In addition, a hydrophilic layer, having a water contact angle of 30° or less, is disposed on a surface (outer peripheral surface) of the ion exchanger 12 adjacent to the treatment section 11.

As with the above-described embodiment, an ion-exchange apparatus, including the tubular ion exchanger 12, includes the raw-water section 10, the treatment section 11, ion exchanger 12 and hydrophilic layer M. The raw-water section 10 contains a to be treated liquid. The liquid includes a liquid that contains impurity ions and is enabled to flow. The treatment section 11 contains a solution (treatment material) with exchange ions including ions exchangeable with the impurity ions. The ion exchanger 12 enables the passage of the impurity ions from the raw-water section 10 to the treatment section 11 and the passage of the exchange ions from the treatment section 11 to the raw-water section 10. Also in this case, the molarity of the solution (treatment material) in the treatment section 11 is set higher than that of the to be treated liquid in the raw-water section 10. Thus, impurity ions in the raw-water section 10 can be removed by enabling the to be treated liquid to flow in the tubular ion exchanger 12. In addition, the hydrophilic layer M, having a water contact angle of 30° or less, is disposed on at least a surface of the ion exchanger 12 adjacent to the treatment section 11, thereby enabling a reduction in the amount of treatment material that permeates the raw-water section 10.

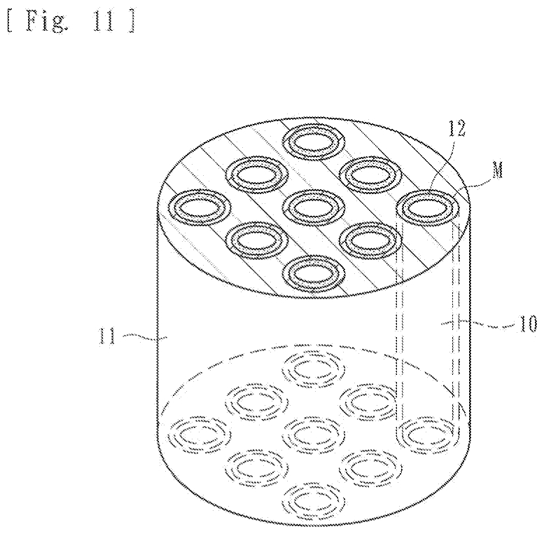

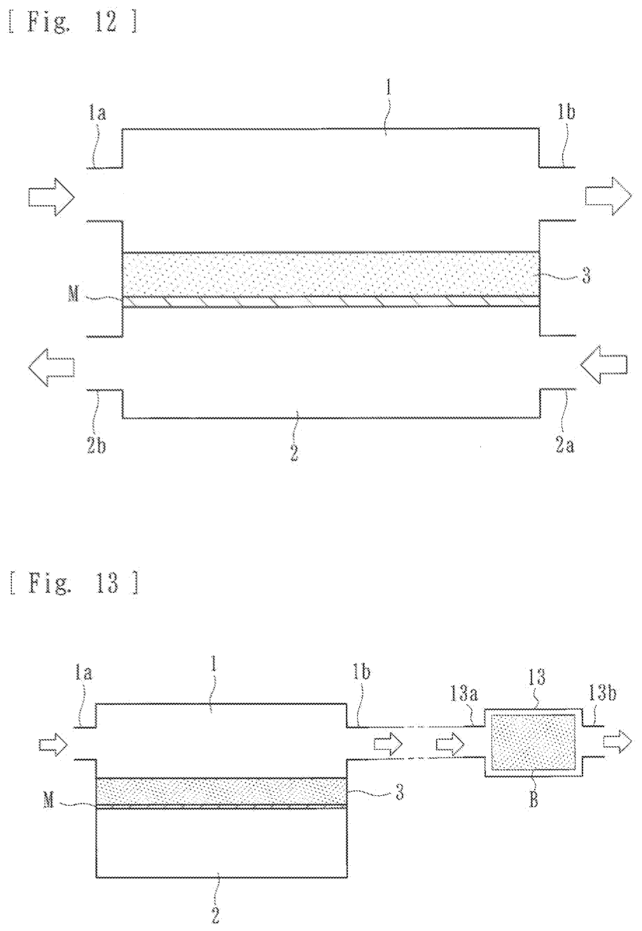

As illustrated in FIG. 11, in the case of hollow fiber ion exchangers 12, a large number of ion exchangers 12 may be arranged in the treatment section 10. In this case, the inside of each hollow fiber ion exchanger 12 serves as the raw-water section 10. The molarity of the solution (treatment material) in the treatment section 11 is set higher than that of a to be treated liquid in the raw-water section 10. Impurity ions in the raw-water section 10 can be removed by enabling the to be treated liquid to flow in each hollow fiber ion exchanger 12. In addition, a hydrophilic layer, having a water contact angle of 30° or less, is disposed on a surface (outer peripheral surface) of each ion exchanger 12 adjacent to the treatment section 11, thereby enabling a reduction in the amount of treatment material that permeates the raw-water section 10. However, the raw-water section and the treatment section may be reversed.

A third embodiment according to the present disclosure will be described below.

As with the above-described embodiment, an ion-exchange apparatus according to this embodiment is used to soften industrial water, produce pure water, or purify, for example, drinking water or cooling water for vehicles by removing impurity ions in liquids to be treated. As illustrated in FIG. 12, it includes raw-water tank 1 provided with the inlet 1a and the outlet 1b, so that a to be treated liquid is enabled to flow, and the treatment tank 2 is provided with the inlet 2a and the outlet 2b, so that the treatment material is enabled to flow.

In the present embodiment, the treatment tank 2 enables the treatment material to flow in the direction opposite to the to be treated liquid in the raw-water tank 1. That is, the to be treated liquid, in the raw-water tank 1, is enabled to flow from left to right in FIG. 12. The treatment material, in the treatment tank 2, is enabled to flow from right to left in the figure. Thus, the to be treated liquid and the treatment material are enabled to flow in opposite directions with the ion exchanger 3 provided therebetween. By enabling the to be treated liquid and the treatment material to flow in the opposite directions, it is possible to reduce the amount of change of the treatment material that increases with time, the amount of the treatment material that permeates and leaks from the treatment tank 2 to the raw-water tank 1.

A fourth embodiment according to the present disclosure will be described below.

As with the above-described embodiment, an ion-exchange apparatus according to this embodiment is used to soften industrial water, produce pure water, or purify, for example, drinking water or cooling water for vehicles by removing impurity ions in liquids to be treated. As illustrated in FIG. 13, it includes an auxiliary treatment section 13 packed with a granular ion exchanger B. The auxiliary treatment section 13 is connected downstream of the raw-water tank 1. The to be treated liquid passed through the raw-water tank 1 can flow into the auxiliary treatment section 13.

Specifically, the auxiliary treatment section 13 is packed with the granular ion exchanger B and includes an inlet 13a, through which the to be treated liquid can flow, and an outlet 13b, through which the treated liquid can flow out. The inlet 13a communicates with the outlet 1b of the raw-water tank 1 with, for example, a connecting member. The granular ion exchanger B is formed of granules composed of the same material as that of the ion exchanger 3 and includes, for example, a granular resin. As described above, since the auxiliary treatment section 13 is connected downstream of the raw-water tank 1, the following effects can be provided.

In an ion-exchange apparatus that does not include the auxiliary treatment section 13, the impurity removal rate is high at a high impurity concentration in a to be treated liquid. However, when the impurity concentration in the to be treated liquid reaches about zero (extremely low concentration), the impurity removal rate is low. In contrast, the granular ion exchanger B, with which the auxiliary treatment section 13 is packed, has a higher specific surface area than the membrane-like ion exchanger 3. Thus, it has a higher impurity removal rate characteristic. Thus, when the auxiliary treatment section 13 is connected downstream of the raw-water tank 1 as in the present embodiment, even if the impurities contained in the to be treated liquid reach about zero (extremely low concentration), the impurities can be removed by the granular ion exchanger B, and a decrease in impurity removal rate can be suppressed. Even if the ion exchanger 3 is damaged to cause the treatment material to flow into the to be treated liquid, the ion exchanger B of the auxiliary treatment section 13 can adsorb ions in the treatment material, thereby preventing a deterioration in water quality.

A fifth embodiment according to the present disclosure will be described below.

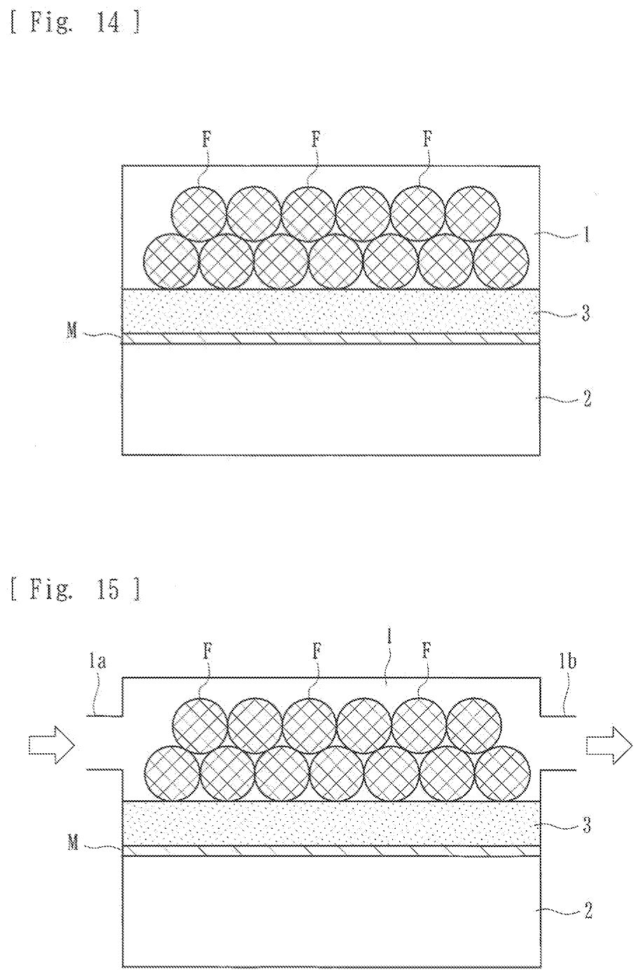

As with the above-described embodiment, an ion-exchange apparatus according to this embodiment is used to soften industrial water, produce pure water, or purify, for example, drinking water or cooling water for vehicles by removing impurity ions in liquids to be treated. As illustrated in FIG. 14, the raw-water tank 1 contains a packed ion exchanger F in contact with the ion exchanger 3. The packed ion exchanger F has the same composition and properties as those of the ion exchanger 3, a spherical shape, and can ensure a large surface area.

That is, the packed ion exchanger F is packed into the raw-water tank 1 to adsorb impurity ions in the to be treated liquid. It enables the impurity ions to pass through the packed ion exchanger F and to move into the ion exchanger 3 owing to the difference in concentration between the inside and the outside. The impurity ions thus moved to the ion exchanger 3 can be removed by enabling the impurity ions to pass through the inside of the ion exchanger 3 to the treatment tank 2. In this case, as illustrated in FIG. 15, the raw-water tank 1 may include the inlet 1a and the outlet 1b so that the to be treated liquid flows in a cavity packed with the spherical packed ion exchanger F.

A sixth embodiment according to the present disclosure will be described below.

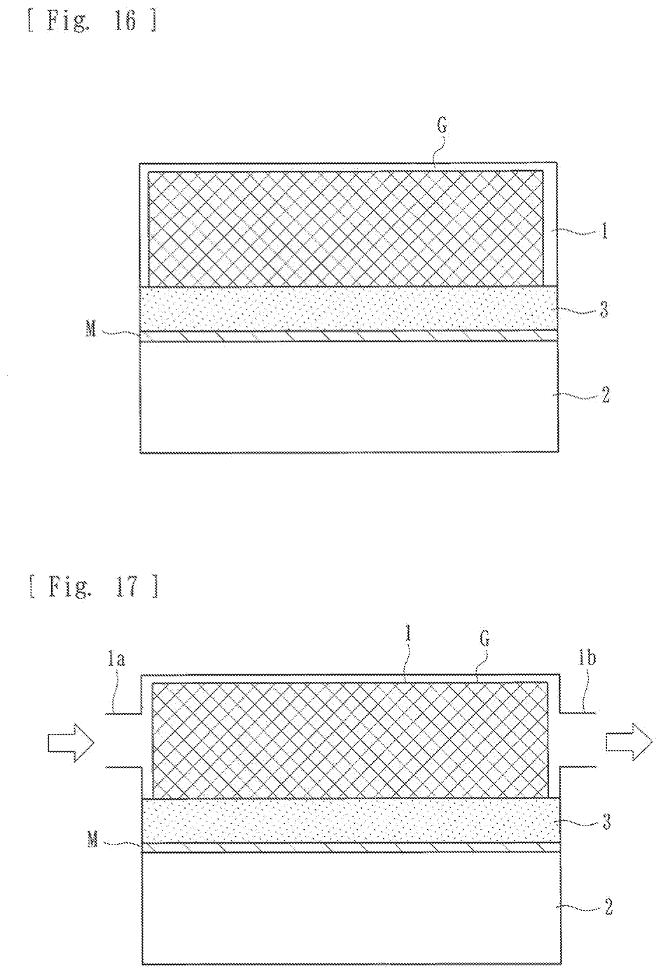

As with the above-described embodiment, an ion-exchange apparatus according to this embodiment is used to soften industrial water, produce pure water, or purify, for example, drinking water or cooling water for vehicles by removing impurity ions in liquids to be treated. As illustrated in FIG. 16, the raw-water tank 1 contains a packed ion exchanger G in contact with the ion exchanger 3. The packed ion exchanger G has the same composition and properties as those of the ion exchanger 3, a fibrous shape, and can ensure a larger surface area.

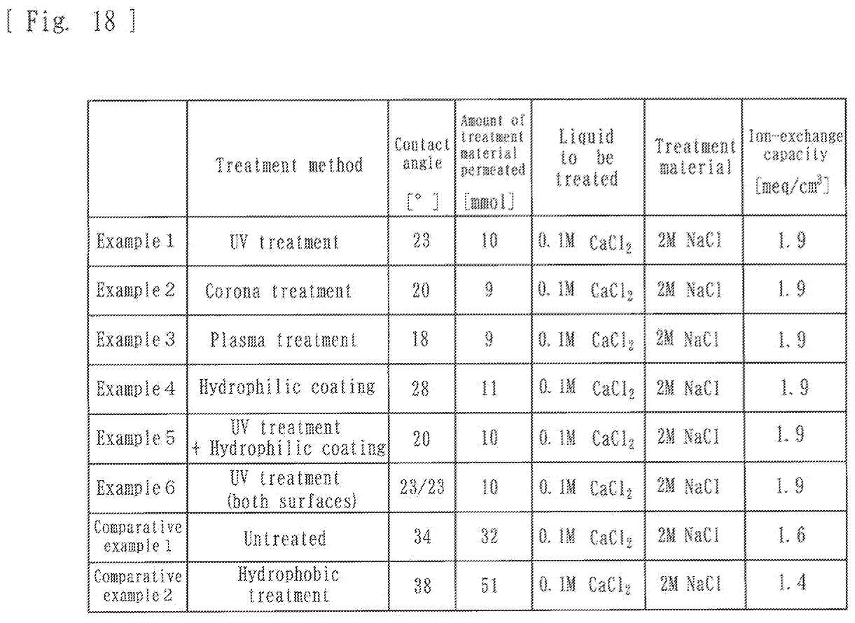

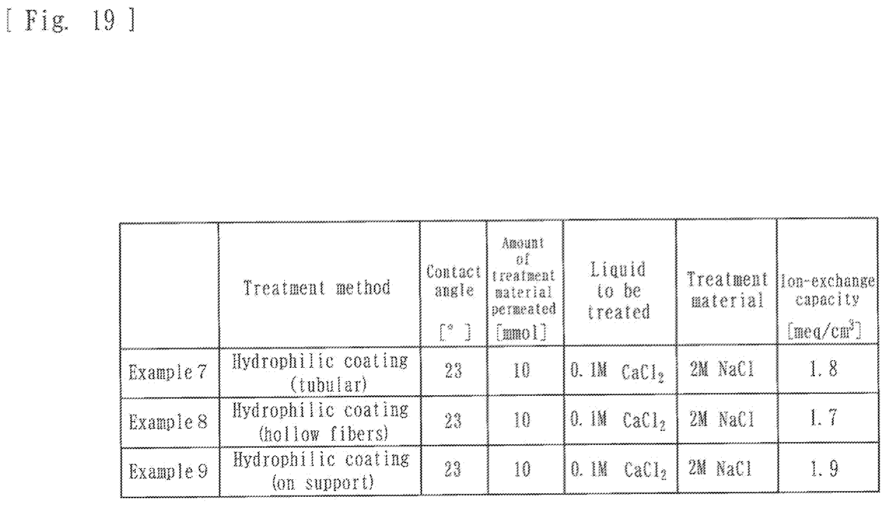

That is, the packed ion exchanger G is packed into the raw-water tank 1 to adsorb impurity ions in the to be treated liquid and enables the impurity ions to pass through the packed ion exchanger G and move into the ion exchanger 3 owing to the difference in concentration between the inside and the outside. In particular, the movement path of the impurity ions can be widely secured by the entanglement of fibers. The impurity ions thus moved to the ion exchanger 3 can be removed by enabling the impurity ions to pass through the inside of the ion exchanger 3 to the treatment tank 2. In this case, as illustrated in FIG. 17, the raw-water tank 1 may include the inlet 1a and the outlet 1b so that the to be treated liquid flows in a cavity packed with the fibrous packed ion exchanger G.

The experimental results exhibiting the technical superiority of the present disclosure will be described below using examples and comparative examples.

### Regarding Examples 1 to 6 and Comparative Examples 1 and 2: See FIGS. 1 and 18

Solutions having predetermined ion concentrations were prepared. Then 90 ml of each solution was placed in a PTFE resin container having a size of 34×64×54 mm (wall thickness: 2 mm, internal volume: 30×60×50 mm). An ion exchanger was disposed on a 34×64 plane. A container measuring 34×64×54 mm (wall thickness: 2 mm, internal volume: 30×60×50 mm) was disposed on the side on which the ion exchanger was disposed. The container was filled with 90 ml of a treatment material and covered with a lid while a pressure was applied with a clamp to prevent leakage of the liquid.

After 3 hours, the impurity ion concentration in the to be treated liquid was measured with an ion chromatograph (940 Professional IC Vario, available from Metrohm AG). The amount of increase in treatment material ions in the to be treated liquid was calculated as the amount of treatment material permeated. When a hydrophilic layer was formed, the contact angle was measured with a DM-301 fully automatic contact angle meter (available from Kyowa Interface Science Co., Ltd). The measurement was performed with pure water having a liquid volume of 4 μl after stopping for 3 seconds after the liquid was placed.

### Example 1

An ion-exchange membrane was irradiated with 365-nm UV for 15 minutes to form a hydrophilic layer having a water contact angle of 23° on its surface. An ion-exchange apparatus was produced by bonding a treatment tank filled with an aqueous sodium chloride solution (2 mol/L) to the hydrophilic layer side of the ion-exchange membrane and bonding a raw-water tank, configured to pass raw water containing impurity ions (Ca²⁺) therethrough, to the other side. As a to be treated liquid (raw water), 0.1 M calcium chloride (CaCl₂) solution was placed. The apparatus was allowed to stand for 3 hours. The amount of sodium chloride permeated was 10 mmol, and the ion-exchange capacity was 1.9 (meq/cm³).

### Example 2

An ion-exchange membrane was subjected to corona treatment to form a hydrophilic layer having a water contact angle of 20° on a surface. An ion-exchange apparatus was produced by bonding a treatment tank filled with an aqueous sodium chloride solution (2 mol/L) to the hydrophilic layer side of the ion-exchange membrane and bonding a raw-water tank, configured to pass raw water containing impurity ions (Ca²⁺) therethrough, to the other side. As a to be treated liquid (raw water), 0.1 M calcium chloride (CaCl₂) solution was placed. The apparatus was allowed to stand for 3 hours. The amount of sodium chloride permeated was 9 mmol, and the ion-exchange capacity was 1.9 (meq/cm³).

### Example 3

An ion-exchange membrane was subjected to plasma treatment to form a hydrophilic layer having a water contact angle of 18° on a surface. An ion-exchange apparatus was produced by bonding a treatment tank filled with an aqueous sodium chloride solution (2 mol/L) to the hydrophilic layer side of the ion-exchange membrane and bonding a raw-water tank, configured to pass raw water containing impurity ions (Ca²⁺) therethrough, to the other side. As a to be treated liquid (raw water), 0.1 M calcium chloride (CaCl₂) solution was placed. The apparatus was allowed to stand for 3 hours. The amount of sodium chloride permeated was 9 mmol, and the ion-exchange capacity was 1.9 (meq/cm³).

### Example 4

An ion-exchange membrane was subjected to hydrophilic coating to form a hydrophilic layer having a water contact angle of 28° on a surface. An ion-exchange apparatus was produced by bonding a treatment tank filled with an aqueous sodium chloride solution (2 mol/L) to the hydrophilic layer side of the ion-exchange membrane and bonding a raw-water tank, configured to pass raw water containing impurity ions (Ca²⁺) therethrough, to the other side. As a to be treated liquid (raw water), 0.1 M calcium chloride (CaCl₂) solution was placed. The apparatus was allowed to stand for 3 hours. The amount of sodium chloride permeated was 11 mmol, and the ion-exchange capacity was 1.9 (meq/cm³).

### Example 5

An ion-exchange membrane was subjected to UV treatment and hydrophilic coating to form a hydrophilic layer having a water contact angle of 20° on a surface. An ion-exchange apparatus was produced by bonding a treatment tank filled with an aqueous sodium chloride solution (2 mol/L) to the hydrophilic layer side of the ion-exchange membrane and bonding a raw-water tank, configured to pass raw water containing impurity ions (Ca²⁺) therethrough, to the other side. As a to be treated liquid (raw water), 0.1 M calcium chloride (CaCl₂) solution was placed. The apparatus was allowed to stand for 3 hours. The amount of sodium chloride permeated was 10 mmol, and the ion-exchange capacity was 1.9 (meq/cm³).

### Example 6

An ion-exchange membrane was subjected to UV treatment to form a hydrophilic layer having a water contact angle of 23° on each surface. An ion-exchange apparatus was produced by bonding a treatment tank filled with an aqueous sodium chloride solution (2 mol/L) to the hydrophilic layer side of the ion-exchange membrane and bonding a raw-water tank, configured to pass raw water containing impurity ions (Ca²⁺) therethrough, to the other side. As a to be treated liquid (raw water), 0.1 M calcium chloride (CaCl₂) solution was placed. The apparatus was allowed to stand for 3 hours. The amount of sodium chloride permeated was 10 mmol, and the ion-exchange capacity was 1.9 (meq/cm³).

### Comparative Example 1

No hydrophilic layer was formed on an ion-exchange membrane. The water contact angle on a surface was 34°. An ion-exchange apparatus was produced by bonding a treatment tank filled with an aqueous sodium chloride solution (2 mol/L) to one side of the ion-exchange membrane and bonding a raw-water tank, configured to pass raw water containing impurity ions (Ca²⁺) therethrough, to the other side. As a to be treated liquid (raw water), 0.1 M calcium chloride (CaCl₂) solution was placed. The apparatus was allowed to stand for 3 hours. The amount of sodium chloride permeated was 32 mmol, and the ion-exchange capacity was 1.6 (meq/cm³).

### Comparative Example 2

An ion-exchange membrane was subjected to hydrophobic coating to form a hydrophilic layer having a water contact angle of 38° on a surface. An ion-exchange apparatus was produced by bonding a treatment tank filled with an aqueous sodium chloride solution (2 mol/L) to the hydrophilic layer side of the ion-exchange membrane and bonding a raw-water tank, configured to pass raw water containing impurity ions (Ca²⁺) therethrough, to the other side. As a to be treated liquid (raw water), 0.1 M calcium chloride (CaCl₂) solution was placed. The apparatus was allowed to stand for 3 hours. The amount of sodium chloride permeated was 51 mmol, and the ion-exchange capacity was 1.4 (meq/cm³).

### Regarding Examples 7 to 9: See FIGS. 9 to 11 and 19

In Example 7, as illustrated in FIGS. 9 and 10, an ion exchanger having a diameter of 15 mm extended in a cylindrical container having a diameter of 20 mm and a length of 300 mm, and a to be treated liquid was allowed to flow through the ion exchanger. In Example 8, as illustrated in FIG. 11, 30 hollow-fiber ion exchangers having an inside diameter of 2 mm extended in a cylindrical container having a diameter of 20 mm and a length of 300 mm. A to be treated liquid was allowed to flow through the ion exchangers.

### Example 7

A tubular ion-exchange membrane was subjected to hydrophilic coating to form a hydrophilic layer having a water contact angle of 23° on a surface. An ion-exchange apparatus was produced by arranging a treatment tank on the hydrophilic layer side of the ion-exchange membrane and arranging a raw-water tank on the other side, the treatment tank being filled with an aqueous sodium chloride solution (2 mol/L), the raw-water tank being configured to pass raw water containing impurity ions (Ca²⁺) therethrough. As a to be treated liquid (raw water), 0.1 M calcium chloride (CaCl₂) solution was placed. The apparatus was allowed to stand for 3 hours. The amount of sodium chloride permeated was 10 mmol, and the ion-exchange capacity was 1.8 (meq/cm³).

### Example 8

Ion-exchange membranes composed of hollow fibers were subjected to hydrophilic coating to form hydrophilic layers each having a water contact angle of 23° on a surface. An ion-exchange apparatus was produced by arranging a treatment tank on the hydrophilic layer side of the ion-exchange membrane and arranging raw-water tanks on the other side, the treatment tank being filled with an aqueous sodium chloride solution (2 mol/L), each of the raw-water tanks being configured to pass raw water containing impurity ions (Ca²⁺) therethrough. As a to be treated liquid (raw water), 0.1 M calcium chloride (CaCl₂) solution was placed. The apparatus was allowed to stand for 3 hours. The amount of sodium chloride permeated was 10 mmol, and the ion-exchange capacity was 1.7 (meq/cm³).

### Example 9

An ion-exchange membrane including a support was subjected to hydrophilic coating to form a hydrophilic layer having a water contact angle of 23° on a surface. An ion-exchange apparatus was produced by arranging a treatment tank on the hydrophilic layer side of the ion-exchange membrane and arranging a raw-water tank on the other side, the treatment tank being filled with an aqueous sodium chloride solution (2 mol/L), the raw-water tank being configured to pass raw water containing impurity ions (Ca²⁺) therethrough. As a to be treated liquid (raw water), 0.1 M calcium chloride (CaCl₂) solution was placed. The apparatus was allowed to stand for 3 hours. The amount of sodium chloride permeated was 10 mmol, and the ion-exchange capacity was 1.9 (meq/cm³).

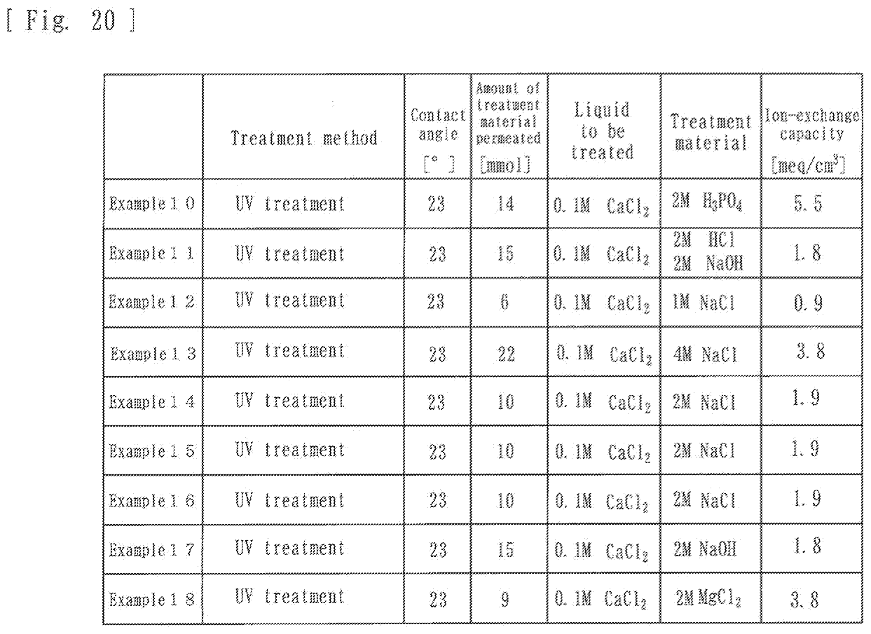

### Regarding Examples 10 to 18: See FIGS. 3 to 8 and 20

### Example 10

An ion-exchange membrane was subjected to UV treatment to form a hydrophilic layer having a water contact angle of 23° on a surface. An ion-exchange apparatus was produced by arranging a treatment tank on the hydrophilic layer side of the ion-exchange membrane and arranging a raw-water tank on the other side, the treatment tank being filled with an aqueous H₃PO₄ solution (2 mol/L), the raw-water tank being configured to pass raw water containing impurity ions (Ca²⁺) therethrough. As a to be treated liquid (raw water), 0.1 M calcium chloride (CaCl₂) solution was placed. The apparatus was allowed to stand for 3 hours. The amount of H₃PO₄ permeated was 14 mmol, and the ion-exchange capacity was 5.5 (meq/cm³).

### Example 11

Ion-exchange membranes were subjected to UV treatment to form hydrophilic layers having a water contact angle of 23° on a surface. An ion-exchange apparatus was produced by arranging two treatment tanks on the hydrophilic layer side of each ion-exchange membrane and arranging a raw-water tank on the other side, one of the two treatment tanks being filled with an aqueous HCl solution (2 mol/L), the other being filled with NaOH solution (2 mol/L), the raw-water tank being configured to pass raw water containing impurity ions (Ca²⁺) therethrough. As a to be treated liquid (raw water), 0.1 M calcium chloride (CaCl₂) solution was placed. The apparatus was allowed to stand for 3 hours. The amount of sodium chloride, a reaction product of permeated HCl and NaOH, permeated was 15 mmol, and the ion-exchange capacity was 1.8 (meq/cm³).

### Example 12

An ion-exchange membrane was subjected to UV treatment to form a hydrophilic layer having a water contact angle of 23° on a surface. An ion-exchange apparatus was produced by bonding a treatment tank filled with an aqueous sodium chloride solution (1 mol/L) to the hydrophilic layer side of the ion-exchange membrane and bonding a raw-water tank, configured to pass raw water containing impurity ions (Ca²⁺) therethrough, to the other side. As a to be treated liquid (raw water), 0.1 M calcium chloride (CaCl₂) solution was placed. The apparatus was allowed to stand for 3 hours. The amount of sodium chloride permeated was 6 mmol, and the ion-exchange capacity was 0.9 (meq/cm³).

### Example 13

An ion-exchange membrane was subjected to UV treatment to form a hydrophilic layer having a water contact angle of 23° on a surface. An ion-exchange apparatus was produced by bonding a treatment tank filled with an aqueous sodium chloride solution (4 mol/L) to the hydrophilic layer side of the ion-exchange membrane and bonding a raw-water tank, configured to pass raw water containing impurity ions (Ca²⁺) therethrough, to the other side. As a to be treated liquid (raw water), 0.1 M calcium chloride (CaCl₂) solution was placed. The apparatus was allowed to stand for 3 hours. The amount of sodium chloride permeated was 22 mmol, and the ion-exchange capacity was 3.8 (meq/cm³).

### Example 14

An ion-exchange membrane was subjected to UV treatment to form a hydrophilic layer having a water contact angle of 23° on a surface. An ion-exchange apparatus was produced by bonding a treatment tank filled with an aqueous sodium chloride solution (2 mol/L) to the hydrophilic layer side of the ion-exchange membrane and bonding a raw-water tank, configured to pass raw water containing impurity ions (Ca²⁺) therethrough, to the other side. As a to be treated liquid (raw water), 0.1 M calcium chloride (CaCl₂) solution was placed and allowed to flow through the raw-water tank for 3 hours. The amount of sodium chloride permeated was 10 mmol, and the ion-exchange capacity was 1.9 (meq/cm³).

### Example 15

An ion-exchange membrane was subjected to UV treatment to form a hydrophilic layer having a water contact angle of 23° on a surface. An ion-exchange apparatus was produced by bonding a treatment tank filled with an aqueous sodium chloride solution (2 mol/L) to the hydrophilic layer side of the ion-exchange membrane and bonding a raw-water tank, configured to pass raw water containing impurity ions (Ca²⁺) therethrough, to the other side. As a to be treated liquid (raw water), 0.1 M calcium chloride (CaCl₂) solution was placed. Stirring was performed in the treatment tank. The amount of sodium chloride permeated was 10 mmol, and the ion-exchange capacity was 1.9 (meq/cm³).

### Example 16

An ion-exchange membrane was subjected to UV treatment to form a hydrophilic layer having a water contact angle of 23° on a surface. An ion-exchange apparatus was produced by bonding a treatment tank filled with an aqueous sodium chloride solution (2 mol/L) to the hydrophilic layer side of the ion-exchange membrane and bonding a raw-water tank, configured to pass raw water containing impurity ions (Ca²⁺) therethrough, to the other side. As a to be treated liquid (raw water), 0.1 M calcium chloride (CaCl₂) solution was placed. Sealing was performed between the treatment tank and the raw-water tank. The apparatus was allowed to stand. The amount of sodium chloride permeated was 10 mmol, and the ion-exchange capacity was 1.9 (meq/cm³).

### Example 17

An ion-exchange membrane was subjected to UV treatment to form a hydrophilic layer having a water contact angle of 23° on a surface. An ion-exchange apparatus was produced by bonding a treatment tank filled with an aqueous NaOH solution (2 mol/L) to the hydrophilic layer side of the ion-exchange membrane and bonding a raw-water tank, configured to pass raw water containing impurity ions (Ca²⁺) therethrough, to the other side. As a to be treated liquid (raw water), 0.1 M calcium chloride (CaCl₂) solution was placed. The apparatus was allowed to stand for 3 hours. The amount of NaOH permeated was 15 mmol, and the ion-exchange capacity was 1.8 (meq/cm³).

### Example 18

An ion-exchange membrane was subjected to UV treatment to form a hydrophilic layer having a water contact angle of 23° on a surface. An ion-exchange apparatus was produced by bonding a treatment tank filled with an aqueous MgCl₂ solution (2 mol/L) to the hydrophilic layer side of the ion-exchange membrane and bonding a raw-water tank, configured to pass raw water containing impurity ions (Ca²⁺) therethrough, to the other side. As a to be treated liquid (raw water), 0.1 M calcium chloride (CaCl₂) solution was placed. The apparatus was allowed to stand for 3 hours. The amount of MgCl₂ permeated was 9 mmol, and the ion-exchange capacity was 3.8 (meq/cm³).

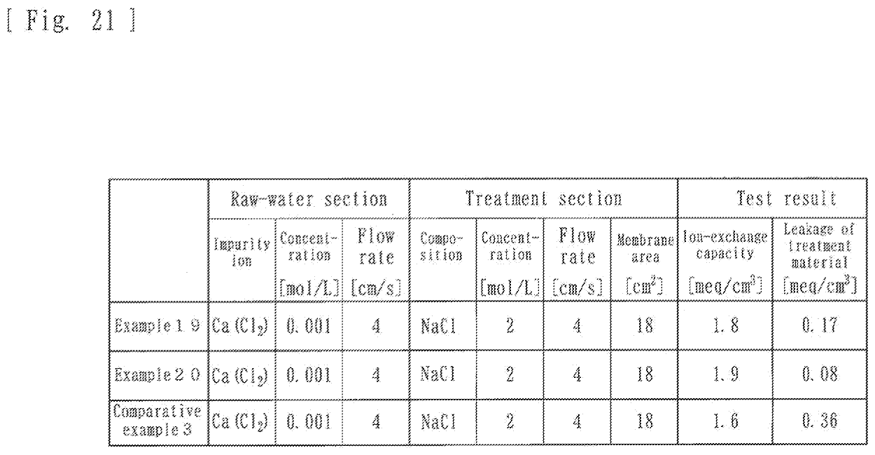

### Regarding Examples 19 and 20 and Comparative Example 3, See FIGS. 12 and 21

The following experimental results obtained in Examples 19 and 20 indicate that the leakage of the treatment material can be suppressed to obtain a higher ion-exchange capacity by allowing the to be treated liquid in the raw-water tank 1 and the treatment material in the treatment tank 2 to flow in opposite directions.

### Example 19

In the raw-water tank 1, the impurity ion in a to be treated liquid was CaCl₂), the concentration was 0.001 (mol/L), and the flow rate was 4 (cm/s). In the treatment tank 2, the composition of a treatment material was NaCl, the concentration was 2 (mol/L), and the flow rate was 4 (cm/s). The ion exchange was performed with an ion exchanger that was subjected to the same treatment as in Example 1 and that had a membrane area of 18 cm² while the to be treated liquid and the treatment material were enabled to flow in opposite directions. The molarities of impurities in the to be treated liquid and the treatment material were measured every 1 minute with an ion chromatograph (940 professional IC Vario, available from Metrohm AG) until no change was observed. If any exchangeable ions remained in the treatment material, the to be treated liquid was replaced again and the same measurement was performed. The measurement was repeated until no change in the concentration of ions exchangeable with impurity ions in the treatment material was observed. The ion-exchange capacity was calculated from the amount of impurity ions in the treatment material. The ion-exchange capacity was 1.8 (meq/cm³), and the leakage of the treatment material (the amount of the treatment material that permeated the raw-water section from the treatment section) was 0.17 (meq/cm³).

### Example 20

In the raw-water tank 1, the impurity ion in a to be treated liquid was CaCl₂), the concentration was 0.001 (mol/L), and the flow rate was 4 (cm/s). In the treatment tank 2, the composition of a treatment material was NaCl, the concentration was 2 (mol/L), and the flow rate was 4 (cm/s). The ion-exchange experiment was conducted with an ion exchanger that was subjected to the same treatment as in Example 1 and that had a membrane area of 18 cm² while the to be treated liquid and the treatment material were enabled to flow in opposite directions (opposite directions indicated in FIG. 12). The ion-exchange capacity was 1.9 (meq/cm³), and the leakage of the treatment material (the amount of the treatment material that permeated the raw-water section from the treatment section) was 0.08 (meq/cm³).

### Comparative Example 3

Comparative example 3 is an example where an ion exchanger was not subjected to hydrophilic treatment. The evaluation was performed in the same manner as in Example 19, except that the ion exchanger was not subjected to hydrophilic treatment. The ion-exchange capacity was 1.6 (meq/cm³), and the leakage of the treatment material (the amount of the treatment material that permeated the raw-water section from the treatment section) was 0.36 (meq/cm³).

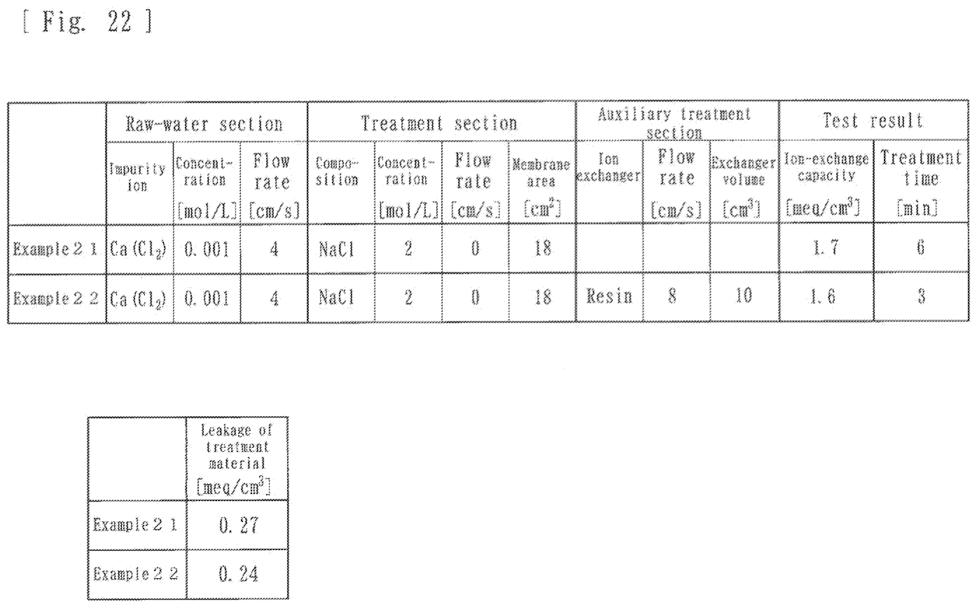

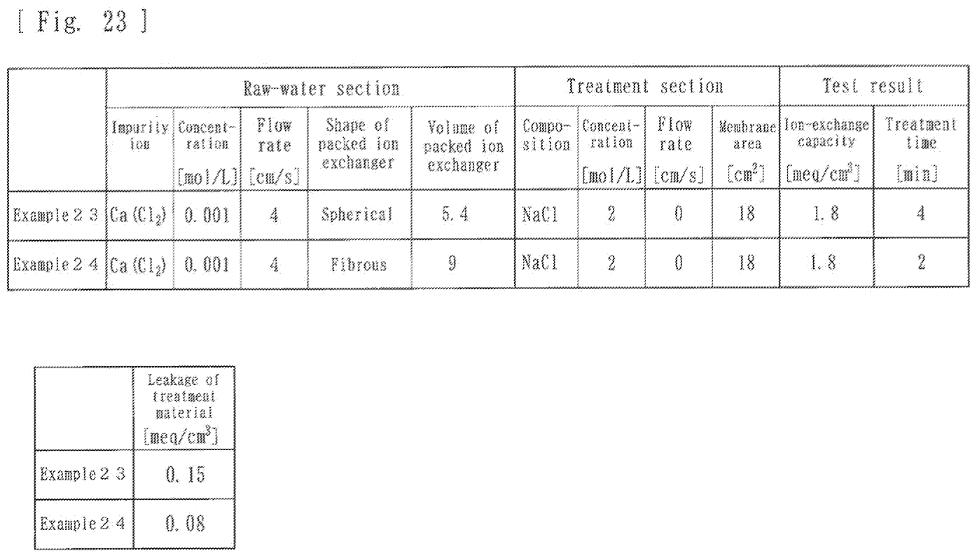

### Examples 21 and 22: See FIGS. 13 and 22

The following experimental results obtained in Examples 21 and 22 indicate that the treatment time can be reduced by the connection of the auxiliary treatment section 13, packed with the granular ion exchanger B, downstream of the raw-water tank 1, thereby leading to a smaller sized ion-exchange apparatus. In addition to the measurement in Example 19, first, the time required to reduce the Ca ion concentration in the raw water to 1 ppm or less was measured.

### Example 21

In the raw-water tank 1, the impurity ion in a to be treated liquid was CaCl₂), the concentration was 0.001 (mol/L), and the flow rate was 4 (cm/s). In the treatment tank 2, the composition of a treatment material was NaCl, the concentration was 2 (mol/L), and the flow rate was 0 (cm/s) (i.e., still water condition). The ion-exchange experiment was conducted with an ion exchanger that was subjected to the same treatment as in Example 1 and that had a membrane area of 18 cm² without connecting the auxiliary treatment section 13. The ion-exchange capacity was 1.7 (meq/cm³), the leakage of the treatment material (the amount of the treatment material that permeated the raw-water section from the treatment section) was 0.27 (meq/cm³), and the treatment time to reduce the impurity ions (Ca ions) in the to be treated liquid to 1 ppm or less was 6 (min).

### Example 22

In the raw-water tank 1, the impurity ion in a to be treated liquid was CaCl₂), the concentration was 0.001 (mol/L), and the flow rate was 4 (cm/s). In the treatment tank 2, the composition of a treatment material was NaCl, the concentration was 2 (mol/L), and the flow rate was 0 (cm/s) (i.e., still water condition). The ion-exchange experiment was conducted with the ion exchanger having a membrane area of 18 cm² while, as illustrated in FIG. 13, the auxiliary treatment section 13 (packed with the granular ion exchanger composed of a resin, flow rate: 8 (cm/s), and exchanger volume: 10 (cm³) (a container having inner dimensions of 5×2×1 cm was packed with the ion-exchange resin)) was connected. The ion-exchange capacity was 1.6 (meq/cm³), the leakage of the treatment material (the amount of treatment material that permeated the raw-water section from the treatment section) was 0.24 (meq/cm³), and the treatment time required to reduce the impurity ions (Ca ions) in the to be treated liquid to 1 ppm or less was 3 (min).

### Regarding Examples 23 and 24: See FIGS. 15, 17, and 23

The following experimental results obtained in Examples 23 and 24 revealed that the time required for ion exchange was reduced by packing the raw-water tank 1 with a spherical packed ion exchanger F in contact with the ion exchanger 3, and that the time required to remove impurity ions was further reduced by packing the raw-water tank 1 with a fibrous ion exchanger G in place of the spherical ion exchanger F.

### Example 23

This is an example in which a raw-water tank 1 was packed with the spherical ion exchanger F. The spherical ion exchanger F (ion-exchange resin) having a diameter of about 0.5 mm was packed to a height of 3 mm while in contact with the ion exchanger 3 that had been subjected to the same treatment as in Example 1. Other than the above respects, the experiment was performed in the same manner as in Example 21. The results indicated that, as illustrated in FIG. 23, the ion-exchange capacity was 1.8 (meq/cm³), the leakage of the treatment material (the amount of treatment material that permeated the raw-water section from the treatment section) was 0.15 (meq/cm³), and the treatment time required to reduce the impurity ions (Ca ions) in the to be treated liquid to 1 ppm or less was 4 (min).

### Example 24

This is an example in which a raw-water tank 1 was packed with a fibrous ion-exchange resin G. The fibrous ion exchanger G (non-woven fabric) was processed into 30×60 mm using Muromac NWF-SC, available from Muromachi Chemicals Inc., and packed thereinto while in contact with the ion exchanger 3 that had been subjected to the same treatment as in Example 1. Other than the above respects, the experiment was performed in the same manner as in Example 21. The results indicated that, as illustrated in FIG. 23, the ion-exchange capacity was 1.8 (meq/cm³), the leakage of the treatment material (the amount of treatment material that permeated the raw-water section from the treatment section) was 0.08 (meq/cm³), and the treatment time required to reduce the impurity ions (Ca ions) in the to be treated liquid to 1 ppm or less was 2 (min).

While the present embodiment has been described above, the present disclosure is not limited. For example, the sizes and shapes of the raw-water tank (raw-water section) and the treatment tanks (first treatment tank and second treatment tank) can be variously set. Any to be treated liquid and any treatment material can be used.

The present disclosure can also be applied to an ion-exchange apparatus to which another device is added as long as the ion-exchange apparatus includes a hydrophilic layer with a water contact angle of 30° or less on at least a surface of an ion exchanger adjacent to a treatment section.

The present disclosure has been described with reference to the preferred embodiment. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

What is claimed:

1. An ion-exchange apparatus comprising:
a raw-water section containing a to be treated liquid, the liquid includes a liquid that contains impurity ions;
a treatment section containing a treatment material with exchange ions including ions exchangeable with the impurity ions;
an ion exchanger enabling passage of the impurity ions from the raw-water section to the treatment section and passage of the exchange ions from the treatment section to the raw-water section;
a hydrophilic layer, with a water contact angle of 30° or less, is disposed on at least a surface of the ion exchanger adjacent to the treatment section.

2. The ion-exchange apparatus according to claim 1, wherein the ion exchanger has a tubular shape, a flat-film shape, or a hollow-fiber shape.

3. The ion-exchange apparatus according to claim 1, wherein the ion exchanger is disposed on a support including a sheet-like fiber layer.

4. The ion-exchange apparatus according to claim 1, wherein the treatment material in the treatment section has a higher molarity than the to be treated liquid in the raw-water section.

5. The ion-exchange apparatus according to claim 4, wherein the treatment material in the treatment section has a molarity of 2 mol/L or more.

6. The ion-exchange apparatus according to claim 1, wherein the raw-water section includes a packed ion exchanger in contact with the ion exchanger that enables passage of the impurity ions from the raw-water section to the treatment section and passage of the exchange ions from the treatment section to the raw-water section.

7. The ion-exchange apparatus according to claim 6, wherein the packed ion exchanger in the raw-water section includes ion-exchange fibers.

8. The ion-exchange apparatus according to claim 1, wherein the raw-water section enables flow of the to be treated liquid.

9. The ion-exchange apparatus according to claim 8, wherein the treatment section enables flow of the treatment material in a direction opposite to the to be treated liquid.

10. The ion-exchange apparatus according to claim 8, further comprising an auxiliary treatment section packed with a granular ion exchanger, wherein the auxiliary treatment section is connected downstream of the raw-water section, and the to be treated liquid passed through the raw-water section flows into the auxiliary treatment section.

11. The ion-exchange apparatus according to claim 1, wherein the treatment section includes a stirrer stirring the treatment material.

12. The ion-exchange apparatus according to claim 1, wherein a seal seals at least one of a joint portions between the raw-water section and the ion exchanger and a joint portion between the treatment section and the ion exchanger.

13. The ion-exchange apparatus according to claim 1, wherein the exchange ions are group 1 element ions or hydroxide ions.

14. The ion-exchange apparatus according to claim 1, wherein the treatment material contains a weak acid or a weak base.

15. The ion-exchange apparatus according to claim 1, wherein the ion-exchange apparatus includes a first treatment section where the exchange ions are group 1 element ions, and
a second treatment section where the exchange ions are hydroxide ions,
wherein each of the first treatment section and the second treatment section is connected to the raw-water section with the ion exchanger provided therebetween.

16. A method for producing an ion-exchange apparatus that includes a raw-water section containing a to be treated liquid, the liquid including a liquid that contains impurity ions:
a treatment section containing a treatment material that has exchange ions including ions exchangeable with the impurity ions;
an ion exchanger that enables passage of the impurity ions from the raw-water section to the treatment section and passage of the exchange ions from the treatment section to the raw-water section,
the method comprising:
forming a hydrophilic layer, with a water contact angle of 30° or less, on at least a surface of the ion exchanger adjacent to the treatment section.

17. The method for producing an ion-exchange apparatus according to claim 16, wherein the hydrophilic layer is formed by subjecting the surface of the ion exchanger adjacent to the treatment section to irradiation of an actinic energy ray, corona treatment, plasma treatment, or coating treatment.
